(19) United States
(12) Patent Application Publication
(10) Pub. No.: US 2014/0349045 A1
(43) Pub. Date: Nov. 27, 2014

(54) COMPOSTABLE LAMINATED PACKAGING MATERIAL

(71) Applicants: Shaun Ashworth, Coquitlam (CA); Alter Eco Americas, Inc., San Francisco, CA (US)

(72) Inventors: Jeanne Cloutier, San Francisco, CA (US); Shaun Ashworth, Coquitlam (CA)

(21) Appl. No.: 14/288,161

(22) Filed: May 27, 2014

Related U.S. Application Data
(60) Provisional application No. 61/827,515, filed on May 24, 2013.

(51) Int. Cl. B65D 30/08; B32B 37/12; B32B 37/06; B32B 7/12; B65D 30/00

(52) U.S. Cl. CPC B65D 31/02; B32B 7/12; B65D 31/005; B32B 37/06; B32B 37/1207; B32B 2250/02; B32B 2255/10; B32B 2255/12; B32B 2309/02; B32B 2367/00; B32B 2405/00; B32B 2439/70
USPC 428/35.4; 428/343; 428/335; 428/195.1; 156/324

(57) ABSTRACT

A laminated packaging material biodegradable under uncontrolled composting conditions comprises a bioplastic sealant layer compostable under uncontrolled composting conditions, and a cellulose barrier layer compostable under uncontrolled composting conditions, wherein the barrier layer is bonded to the sealant layer with a water-based dry bond adhesive including a hydroxyl or an aziridine cross-linking coreactant and having polyurethanes or acrylics only in concentrations less than 0.1% of the dry weight of the packaging material.

### CROSS-REFERENCE TO RELATED APPLICATIONS

This applicant claims the benefit of U.S. Provisional Application No. 61/827,515 filed May 24, 2013.

### BACKGROUND OF THE INVENTION

1. Field of the Invention

This invention relates to biodegradable laminated packaging and more particularly to a flexible package comprising laminated bioplastic materials capable of decomposing under controlled or uncontrolled composting conditions into usable humus without leaving toxic residue. In one embodiment, the packaging incorporates a reclosure.

2. Description of Related Art

Flexible packages are a ubiquitous presence in contemporary society, providing a convenient and safe means of storing small items, particularly food products. Typical flexible packages are an outgrowth of high-density polyethylene (HDPE) containers and are manufactured from petroleum based films, usually laminated to another petroleum-based foil or paper layer. The universal acceptance of flexible packages is a testament to their convenience, durability and practicality, but has resulted in a significant and growing volume of such material being discarded into landfills and into the world's oceans where they act as a long term contaminant and pose a danger to numerous forms of life. Flexible packaging comprised of petroleum-based materials can take up to twenty years to break down as roadside litter or as many as eight hundred years to dissolve in a landfill. Even if petroleum-based packaging material eventually decomposes, it leaves behind residue that is useless waste or toxic. Moreover, these materials cannot be recycled as they are more often than not in laminated form comprised of different petroleum-based layers.

Flexible packaging material has in recent years been embraced by the retail and grocery food industry as a convenient and consumer-friendly means of packaging and presenting food products. It has, therefore, become increasingly important to develop a flexible packaging material that does not create an added burden on the environment. While notable progress has been made in creating flexible packaging material that is biodegradable, no laminated flexible package has been developed that is compostable under uncontrolled composting conditions, sometimes referred to as “home” composting.

A major development in the creation of environmentally friendly packaging material has been the development of biodegradable plastic, commonly known as “bioplastic.” Bioplastic is manufactured from renewable materials such as cellulose or corn, rather than petroleum-based substances. Unfortunately, most currently available laminated flexible packaging material made from bioplastic also incorporates a measure of petroleum-based products. Thus, while the presently available generation of bioplastic based flexible packages may be biodegradable or oxodegradable, they can leave toxins in the environment.

Another problem with bioplastic flexible packages available under the prior art is that they are not biodegradable under uncontrolled conditions generally experienced in home composting sites, or in nature. Some bioplastics are biodegradable, but only in controlled industrial composting facilities that maintain temperatures of 140° F. or above along with other specified conditions including controlled moisture and oxygen levels, and mechanical turning rules. Materials that are biodegradable under industrial composting conditions are not always biodegradable in uncontrolled composting conditions. According to the ASTM-D6400 compostability standard, issued by the American Society for Testing and Measurement, in order to be compostable, a product must be biodegradable in a compost site and break down to carbon dioxide, water, inorganic compounds, and biomass, at a rate consistent with known compostable materials, such as cellulose, and leave no toxic residue. To be truly compostable, the end result of the decomposition must be usable humus. In order to be home compostable, the material must compost under common home composting conditions in less than six months.

There is currently no written standard for “home compostability” in the United States. However, applicants have identified the Vinçotte OK Compost HOME certification as the most relevant standard for home compostability. The Vinçotte OK Compost HOME certification, issued by AIB-Vinçotte International S.A., located in Brussels, Belgium, requires that a product must disintegrate under common home composting conditions leaving only useful humus.

Another impediment to a truly environmentally-friendly packaging material results from the use of genetically modified organisms (GMOs). Some bioplastics are made from GMOs. The effects of GMOs on the environment are still being studied, but many feel that it would be best not to package food in materials having an uncertain impact on the environment and on human health.

Product packaging, whether or not eco-friendly, must be able to carry the weight of the contents contained in the packaging and provide a barrier which protects the contents from typical handling conditions, such as those experienced during transportation and in retail settings, and from ambient climate changes, such as fluctuations in temperature and humidity.

A stand up pouch (SUP) is characterized by two side seals and a bottom gusset enabling the package to rest upright. An important aspect of an SUP is that it is capable of standing upright on a shelf in order to present one face as a marketing “billboard,” a feature that is not available if using a pillow-style bag which is generally stacked on its side. Standing the SUP on its end necessarily exerts added pressure on the side and bottom gusset seals.

Heretofore, the Achilles heel in the development of a laminated non-GMO based compostable SUP has been the sealant layer. The seals in most prior art bioplastic SUPs use petroleum-based materials which are neither biodegradable nor recyclable, but have good sealing properties. Good side seals are essential to a viable non-GMO bioplastic SUP absent which the SUP is limited to holding light-weight products.

Cellulose films are known to have good moisture barrier properties and to deflect oxygen and other gases. Moreover, a cellulose film can be sealed to itself and used to manufacture a product package. The seal strength of cellulose film to cellulose film, however, is only strong enough to permit the resulting package to hold lighter weight products. Thus, a package formed from cellulose film alone would not have seals strong enough to hold a heavier product, such as rice. In addition, when exposed to normal use a package consisting of cellulose film alone is susceptible to tears which propagate easily once started, rendering the package useless. Cellulose film cannot, therefore, be used alone to build an SUP for holding products having substantial volume or weight. In addition, cellulose film alone does not have sufficient rigidity to form an SUP that will stand upright.

Prior to the development of applicants' invention, no non-GMO based bioplastic product package that is biodegradable under home composting conditions has been successfully manufactured. Currently available SUPs are not biodegradable under home composting conditions, may leave unacceptable levels of eco-toxins after decomposition, are comprised of GMO-based bioplastics, or do not have sufficiently strong seals to hold the weight of the products contained in the package.

### BRIEF DESCRIPTION OF THE ILLUSTRATIONS

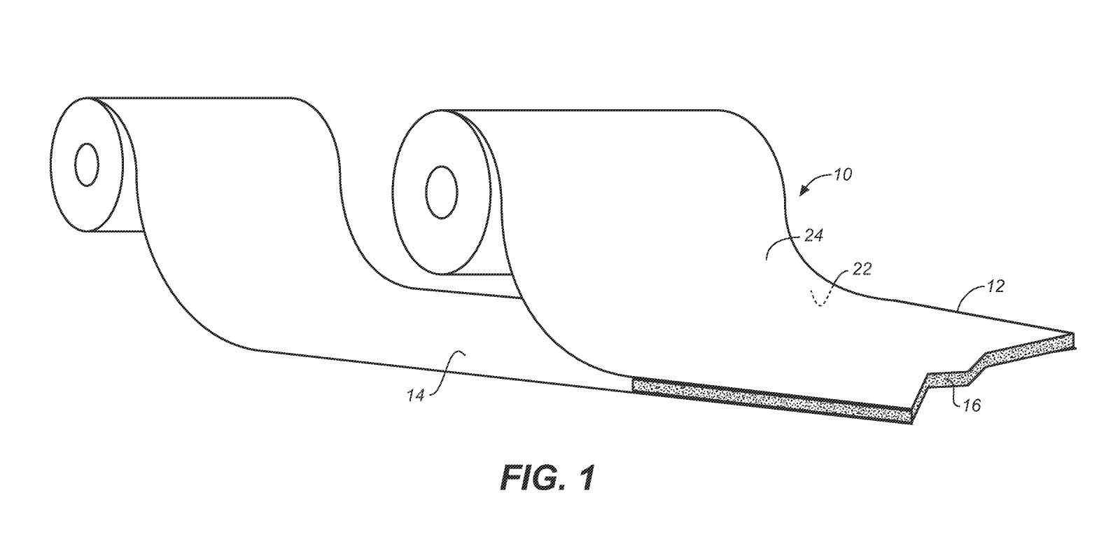

FIG. 1 is a schematic diagram of the component layers of a laminated bioplastic packaging material biodegradable under home composting conditions.

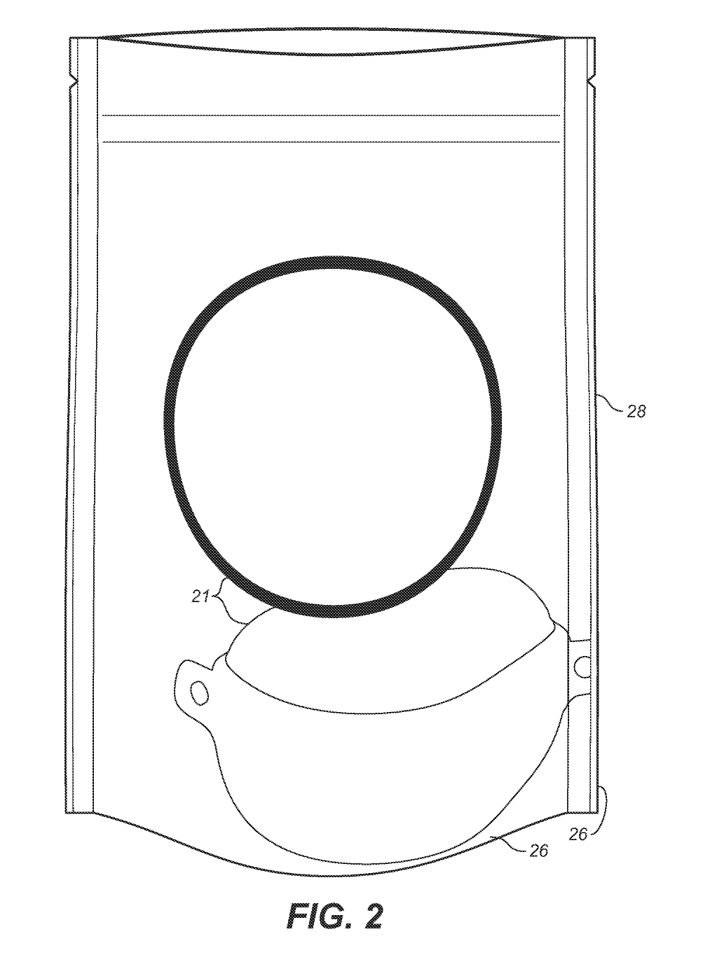

FIG. 2 is an image of a stand up pouch.

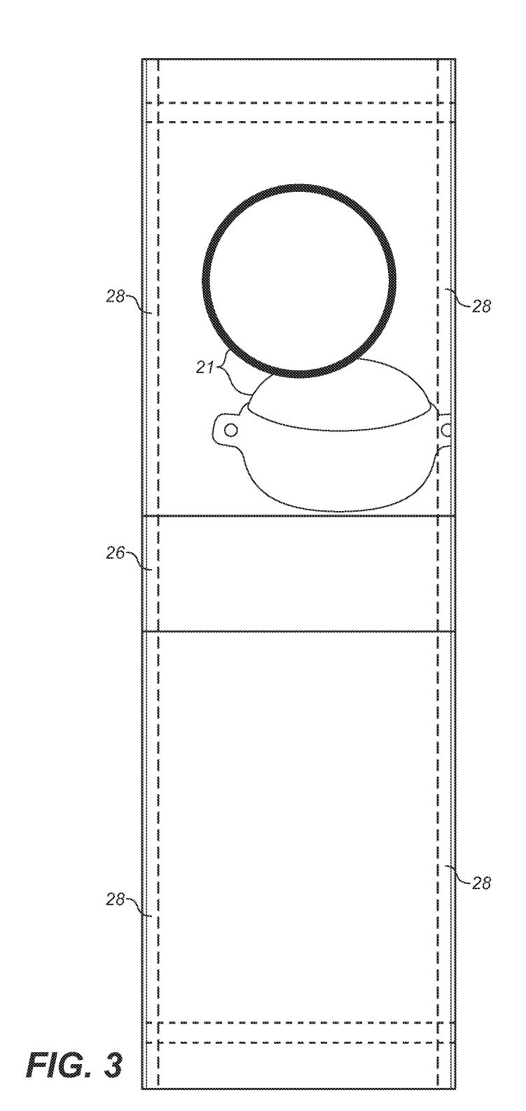

FIG. 3 is an image of a specification sheet for a stand up pouch according to the invention.

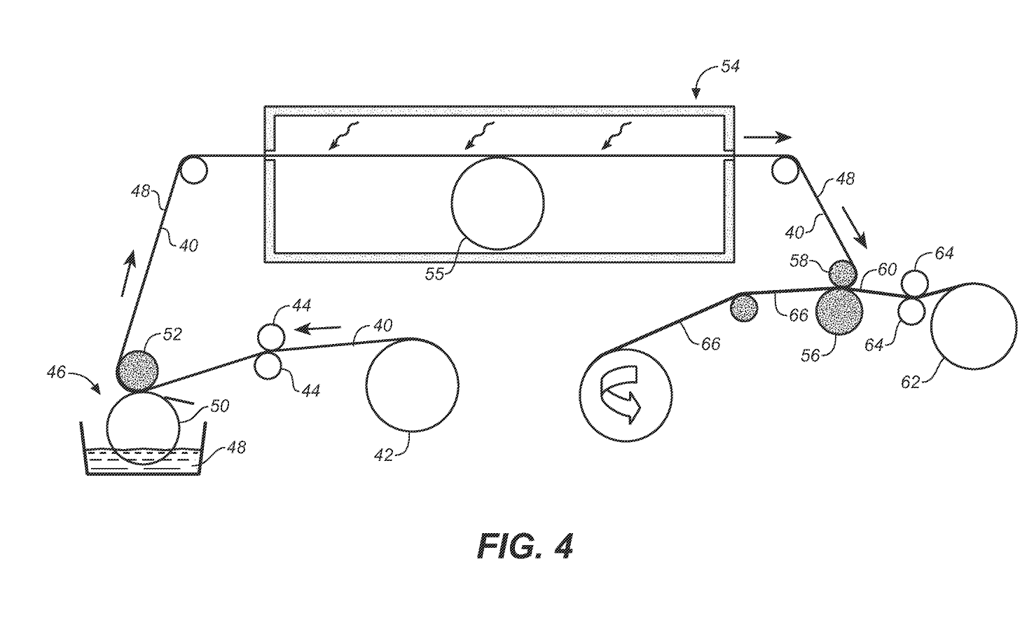

FIG. 4 is a schematic diagram of the process of laminating the barrier and sealant layers of the packaging material shown in FIG. 1.

### DETAILED DESCRIPTION OF THE ILLUSTRATED EMBODIMENT

A laminated bioplastic packaging material biodegradable under home composting conditions, referred to generally at numeral 10 in FIG. 1, comprises a barrier layer 12 composed of a compostable cellulose film bonded to a sturdy bioplastic sealant layer 14 using a water-base dry bond adhesive 16 in combination with a hydroxyl or an aziridine cross-linking coreactant 18. The combination has been found to provide good barrier protection, a strong bond between the barrier and, sealant layers, and well-bonded seals.

An important feature of the invention is that the material, once formed into an enclosed product package, provides good barrier properties against oxygen and moisture, especially when used to package food products. The barrier layer may comprise a compostable non-GMO cellulose or thermoplastic aliphatic polyester (PLA) film. In some embodiments, the barrier layer is compostable under uncontrolled composting conditions. And in some embodiments the barrier layer may be metallised to improve the barrier properties of the film.

Applicants have determined that NatureFlex™ film available from Innovia Films Inc., having offices in Atlanta, Ga., is a suitable material to comprise the barrier layer. NatureFlex film has good moisture barrier properties and will block the transmission of oxygen and other gases that might cause a packaged food product to deteriorate. NatureFlex film has also been certified to be home compostable under the Vinçotte OK Compost HOME standard. NatureFlex film in a thickness no greater than 3 mils having an oxygen transfer rate no greater than 0.06 cc/100 in² in 24 hours at 75° F. and 0% RH and a water vapor transfer rate no greater than 2.9 g/100 in² in 24 hours at 77° F. and 75% RH will be an appropriate barrier layer. In preferred embodiments of the invention, NatureFlex film having a thickness of between 0.75 to 1.20 mils comprises the barrier layer. NatureFlex D-NE 90 film, having a thickness of 0.87 mils, is a suitable material for the barrier layer. In another embodiment NatureFlex N950 film, having a thickness of 0.92 mils, an oxygen transfer rate no greater than 0.06 cc/100 in² in 24 hours at 75° F. and 0% RH and a water vapor transfer rate no greater than 1.9 g/100 in² in 24 hours at 100° F. and 90% RH is a suitable alternative for the barrier layer.

Another important feature of a compostable packaging material according to the invention is that the package must have good sealant properties that guard against undesirable excess transmission of oxygen and moisture. A nor compostable film comprised of a minimum of 70% plant-based materials is an appropriate material for the sealant layer. Applicants have identified Mater-Bi® film, manufactured from bioplastic resins by Novamont S.p.A, located in Novara, Italy, as a suitable material for the sealant layer. Mater-Bi bioplastics are derived from plants and renewable raw materials, can be used in place of traditional plastics, and are biodegradable and compostable. Mater-Bi films are certified as being home compostable under Vinçotte's OK compost standard. Mater-Bi films have good strength characteristics (tensile strength=21 Mpa at 1 mm thickness under ASTM D-882) and provide the durability needed to form an SUP. Mater-Bi films, however, are porous, making them unsuitable alone for packaging food products due to unacceptable transmission rates of oxygen and water. Nevertheless, Mater-Bi bioplastics have been used to manufacture pet waste bags and trash bags wherein porosity is noncritical. A significant advantage of a Mater-Bi bioplastic is that the material will form a strong seal when bonded to itself—an important advantage for forming the side and bottom gusset seals of an SUP. Mater-Bi NF Series film, having a thickness of approximately 2 mils, is a suitable material to comprise the sealant layer. Those of skill in the art will understand that a non-GMO compostable bioplastic composed of at least 70% plant-based renewable materials may comprise the sealant layer.

The barrier layer 12 is bonded to the sealant layer 14 according to the invention with an adhesive that is compostable and free of solvents. A water-based dry bond adhesive has the advantage of being compostable and free of non-biodegradable solvents. However, the bonding strength of the seals formed with only water-based dry bond adhesive may not be sufficient to form a package capable of securely holding heavier products. Applicants have determined that the addition of a coreactant to a water-based dry bond adhesive increases the bonding strength sufficiently to bond the barrier layer to the sealant layer. While it is known in the adhesive arts to use an hydroxyl or aziridine crosslinker in combination with a water-based dry bond adhesive on conventional films, such as polyesters and polyethylenes, the combination of a compostable barrier layer bonded to a compostable sealant layer using a water-based adhesive, in combination with a hydroxyl or an aziridine crosslinker, is novel. Applicants have determined that Flextra_{WB}™ SFA 8210 Water Base Dry Bond adhesive, an isocyanate, available from H. B. Fuller, located in St. Paul, Minn., is a suitable adhesive according to the invention. Applicants have identified Flextra_{WB}™ XR1210, a hydroxyl, also available from H. B. Fuller, as a suitable crosslinker in combination with the water base dry bond adhesive. In other embodiments, an aziridine cross-linker may be used as a suitable crosslinker in combination with the water base dry bond adhesive.

A structure that includes an adhesive having polyurethanes or acrylics cannot be certifiable as home compostable under the Vinçotte OK Compost HOME standard unless the polyurethanes or acrylics are present in concentrations less than 0.1% of the dry weight of the total structure. Therefore, one of skill in the art will recognize that other adhesives or adhesive-coreactant mixtures may be used in the invention if they achieve an adequate bond between the barrier and sealant layers 12, 14 and are used in acceptably low concentrations.

A laminated bioplastic packaging material biodegradable under home composting conditions is thus formed from a compostable cellulose film having good moisture and gas barrier properties, and a compostable sealant layer composed of a bioplastic film manufactured from plants or renewable raw materials bonded to the barrier layer using a water-based dry bond adhesive mixed with an aziridine crosslinker.

In some embodiments of the invention, a resealable package closure may be heat sealed to opposing portions of the Mater-Bi sealant layer 14 thereby forming a compostable SUP. The closure may be selected from non-GMO compostable materials composed of at least 70% of plant-based renewable materials. A suitable compostable closure is the BIOZIP® ZG99Bio zipper (“BIOZIP zipper”) available from Groupe Flexico, Henonville, France. The BIOZIP zipper is manufactured entirely from Mater-Bi bioplastics, and is certified as being compostable under Vinçotte's OK compost standard.

In another aspect of the invention the barrier layer may be reverse printed with product messages using a water-based compostable ink such that the ink is disposed between the barrier and sealant layers. However, the scope of the invention is not intended to be limited to biodegradable product packages or SUPs containing printed matter.

Unfortunately, no compostable ink is presently available in North America. If, however, the concentration of ink in a product is no more than one-tenth of one percent (0.1%), the ink does not have to be separately tested for ecotoxicity to certify the product as home compostable under the Vinçotte OK Compost HOME standard, provided there are no heavy metals in the ink. If ink is tested for ecotoxicity, the product is certifiable as home compostable under the Vinçotte OK Compost HOME standard, if the ink is used in a concentration no greater than one percent (1%), provided no heavy metals are present. Finally, a product can be certified as home compostable under the Vinçotte OK Compost HOME standard ink in which no ecotoxins are present is used in a concentration up to one percent (1%), assum ing the negative presence of heavy metals, and any ink containing no heavy metals may be used in a concentration not to exceed one-tenth of one percent (0.1%). If the total weight of the ink in a package is five percent or less, and each individual color is less than one percent of the total weight, the package is deemed to be compostable under the Vinçotte OK Compost standard.

According to the invention, a water-based ink 20 is used for printing a product message 21 on the barrier layer 12. In one embodiment the message is reverse printed on the inside face 22 of the barrier layer 12 so that, once the sealant layer 14 is laminated to the barrier layer 12, the printed message appears, properly oriented, from the outside face 24 of the barrier layer. This not only entraps and protects the ink but interposes the sealant layer as a protective barrier between the ink 20 and food products enclosed by a package made from the laminated material.

Applicants have determined that Hydrofilm Ace™ NO WAX (HMJ) ink (“Hydrofilm Ace ink”), available from Flint Group, located in Luxembourg, is a suitable ink according to the invention. Hydrofilm Ace ink was designed for use on non-porous, synthetic substrates for applications where lamination or overprinting is required. Hydrofilm Ace ink has been used for printing on polyester and polyethylene films, providing good substrate adhesion. But, Hydrofilm Ace ink has not heretofore been used for printing on cellulose film, and particularly, not on NatureFlex film. The total weight of Hydrofilm Ace ink present in the package is approximately 3.56%. Therefore, a packaging material having a barrier layer bonded to a sealant layer using a water-based adhesive as described above, in which a product message has been reverse printed barrier layer, wherein the total weight of ink present in the package is no more than five percent, is compostable.

With reference to FIGS. 2 and 3, an SUP is manufactured from the laminated material by forming bottom gusset seals 26 and side seals 28. As shown, the gusset and side seals 26, 28 are formed by folding the sealant layer 14 back upon itself and heat sealing it together.

The process for manufacturing a laminated bioplastic packaging material biodegradable under uncontrolled composting conditions relies on a unique set of temperature and pressure settings, proper coat weight of the adhesive, and timing. Flexible laminated packaging material according to the invention is made by laminating the barrier layer to the sealant layer using the adhesive/coreactant mixture discussed above, curing the laminated combination for 48 to 72 hours, and converting the laminated materials into an SUP by sealing the sealant layer together to form side and bottom gussets.

With reference now to FIG. 4, the laminating process according to the invention is described. Initially the barrier layer 40 is unwound from roll 42, passed through feed rolls 44 to an adhesive coating station 46. An adhesive coating 48 is picked up by an anilox roll 50 from a storage container and, applied to the film 40 as it is passed between the anilox roil and cooperating impedance roller 52.

Ensuring that the NatureFlex barrier layer is well-bonded to the Mater-Bi sealant layer depends on applying the proper coat weight of the adhesive mix between the layers. If too much adhesive is used, the mixture will not cure quickly enough. If too little adhesive is used, the bond between the layers will be too weak. Applicants have determined that the proper coat weight of Flextra SFA 8210 adhesive to bond the NatureFlex barrier layer 12 to the Mater-Bi sealant layer 14 is 2.5-3.5 lbs/ream wherein a ream is 3,000 ft².

With continuing reference to FIG. 4, the adhesive-coated film is next passed through a dryer 54 which runs the film over a hot drum 55 and simultaneously air dries the adhesive coating until tacky. The temperature of the drum 55 must be between 220° F. and 240° F. to, in combination with the air drying, remove enough moisture from the adhesive to form a strong bond during the lamination stage.

The coated film 40 is then passed between a nip roller 56 and cooperating impedance roller 58. The sealant layer 60 is simultaneously unwound from storage roll 62 and directed by feed rollers 64 between the nip roller 56 and impedance roller 58 where the barrier layer 40 and sealant layer 60 are pinched together and bonded by the adhesive to form a laminated packaging material 66 according to the invention.

The temperature of the nip roller should be maintained between 140° F. and 191° F. Applicants have determined that a suitable temperature range for the nip roller 50 while joining the barrier and sealant layers 40, 60 is between 150° F. and 190° F. and that the optimal temperature is approximately 180° F. The correct temperature ensures not only that the adhesive will join the barrier and sealant layers 40, 60, but that all remaining moisture in the adhesive is removed and that any bubbles and blisters between the film layers are eliminated. The pressure setting of the nip roller must be between 15 to 20 PSI.

After the adhesive mix has been applied and the barrier and sealant layers 40, 60 have been bonded, the laminated material is passed onto a winder roll and cured for 48 to 72 hours at temperatures between 68° F. and 90° F. Applicants have determined that a suitable temperature range for curing the laminated films is from 70° F. to 80° F., and that the optimal range is 72° F. to 78° F.

The process of converting the laminated material into an SUP is shown in FIG. 5. The first step is to secure a roll of the laminated material on the unwind portion of the machine. The second step is to form and fold the front and back of the bag using a plough bar. The third step is to open up the middle fold to form the bottom gusset. The fourth step is to seal the bottom gusset using heat seal bars. The fifth step is to form the side seals using vertical heal seal bars. The sixth step is to cool the side seals using cold seal bars. The seventh step is to form the tear notch at the top of the bag. The eighth step is to trim the bag to a specified height. The ninth step is to trim the newly formed pouch to a specified width.

A laminated bioplastic packaging material biodegradable under home to composting conditions as described above meets the Vinçotte OK home compostable standard. A significant advantage of the invention is that after a consumer's use of the product stored in the package, it can be discarded in a home compost pile where it will biodegrade into useful humus. In one aspect of the invention, if printed indicia, such as a product message, has been printed on the barrier layer, the packaging material is compostable at least under controlled conditions if the total weight of ink present in the package is no more than five percent. In another aspect of the invention, an SUP formed from laminated bioplastic packaging material, wherein the SUP includes a closure, is compostable under controlled conditions.

There have thus been described and illustrated certain embodiments of a laminated packaging material biodegradable under uncontrolled composting conditions according to the invention. Although the present invention has been described and illustrated in detail, it should be clearly understood that the disclosure is illustrative only and is not to be taken as limiting, the spirit and scope of the invention being limited only by the terms of the appended claims and their legal equivalents.

We claim:

1. A compostable laminated packaging material comprising:
a sealant layer compostable under uncontrolled composting conditions, and
a barrier layer compostable under uncontrolled composting conditions, said barrier layer bonded to said sealant layer with a water-based dry bond adhesive, said adhesive including a cross-linking coreactant,
wherein the laminated packaging material is compostable under controlled or uncontrolled conditions.

2. The compostable laminated packaging material of claim 1 wherein:
said sealant layer comprises bioplastic.

3. The compostable laminated packaging material of claim 2 wherein:
said sealant layer has a thickness of approximately two mils.

4. The compostable laminated packaging material of claim 1 wherein:
said barrier layer comprises a cellulose film.

5. The compostable laminated packaging material of claim 4 wherein:
said cellulose film has
an oxygen transfer rate no greater than 0.06 cc/100 in² per day at 75° F. and 0% RH, and
a water vapor transfer rate no greater than 2.9 g/100 in² per day at 77° F. and 75% RH.

6. The compostable laminated packaging material of claim 1 wherein:
said barrier layer comprises a film selected from the group of non-GMO cellulose and thermoplastic aliphatic polyester films.

7. The compostable laminated packaging material of claim 1 wherein:
said adhesive comprises polyurethanes or acrylics in concentrations less than 0.1% of the dry weight of the packaging material.

8. The compostable laminated packaging material of claim 1 further comprising:
written indicia printed on said barrier layer using ink having a weight of five percent or less of the total weight of the packaging material, wherein the laminated packaging material is compostable only under controlled conditions.

9. The compostable laminated packaging material of claim 1 further comprising:
a resealable package closure comprising a compostable bioplastic, wherein the laminated packaging material is compostable only under controlled conditions.

10. The compostable laminated packaging material of claim 1 further comprising:
a hermetically sealed package formed from a laminated sheet comprising said sealant layer, said barrier layer and said adhesive, said laminated sheet having opposing halves, side edges and end edges,
wherein said laminated sheet is folded back upon itself bringing the sealant layer of each half in contact with the sealant layer of the other half, and the sealant layers of said halves are sealed to each other at said side and end edges thereby forming an enclosure.

11. The compostable laminated packaging material of claim 10 wherein:
said hermetically sealed package forms a stand-up pouch.

12. The compostable laminated packaging material of claim 1 wherein:
said water-based dry bond adhesive has a coat weight of between approximately 2.5 and 3.5 lbs per ream.

13. A laminated packaging material biodegradable under uncontrolled composting conditions comprising:
a compostable sealant layer comprising bioplastic film compostable under uncontrolled composting conditions, said sealant layer having a thickness of approximately two mils, and
a compostable barrier layer comprising a cellulose film compostable under uncontrolled composting conditions, said cellulose film having
an oxygen transfer rate no greater than 0.06 cc/100 in² per day at 75° F. and 0% RH, and
a water vapor transfer rate no greater than 2.9 g/100 in² per day at 77° F. and 75% RH,
said barrier layer bonded to said sealant layer with a water-based dry bond adhesive, said adhesive including a hydroxyl or an aziridine cross-linking coreactant.

14. The compostable laminated packaging material of claim 13 wherein:
said adhesive includes polyurethanes or acrylics only in concentrations less than 0.1% of the dry weight of the packaging material.

15. A method for making a compostable laminated packaging material comprising:
coating a barrier layer with a water-based dry bond adhesive at a coat rate of between approximately 2.5 and 3.5 lbs per ream, said barrier layer compostable under uncontrolled composting conditions, said adhesive including a hydroxyl or aziridine cross-linking coreactant,
passing said adhesive-coated barrier layer across a hot drum heated to a temperature of between approximately 220° F. and 240° F.,
air drying said adhesive until tacky, and
passing said adhesive-coated barrier layer and a sealant layer between a nip roller and a cooperating impedance roller to form a laminated material.

16. The method for making a compostable laminated packaging material of claim 15 wherein:
said nip roller has a temperature between approximately 140° F. and 191° F.

17. The method for making a compostable laminated packaging material of claim 16 wherein:
said nip roller has a temperature of approximately 180° F.

18. The method for making a compostable laminated packaging material of claim 16 wherein:
said nip roller has a pressure setting of between approximately 15 and 20 PSI,

19. The method for making a compostable laminated packaging material of claim 15 further comprising:
curing said laminated material for between approximately 48 to 72 hours at between approximately 70° F. to 80° F.

20. A method for making a compostable laminated packaging material comprising:
coating a barrier layer with a water-based dry bond adhesive at a coat rate of between approximately 2.5 and 3.5 lbs per ream, said barrier layer comprising a bioplastic film having a thickness of approximately two mils, an oxygen transfer rate no greater than 0.06 cc/100 in² per day at 75° F. and 0% RH, and a water vapor transfer rate no greater than 2.9 g/100 in² per day at 77° F. and 75% RH, said barrier layer compostable under uncontrolled, composting conditions, said adhesive including a hydroxyl or an aziridine cross-linking coreactant,
passing said adhesive-coated barrier layer across a hot drum heated to a temperature of between approximately 220° F. and 240° F.,
air drying said adhesive until tacky,
passing said adhesive-coated barrier layer and a sealant layer between a nip roller and a cooperating impedance roller at a pressure of between approximately 15 and 20 PSI to form a laminated material, said nip roller having a temperature of approximately 180° F., said sealant layer comprises a bioplastic film having a thickness of approximately 2 mils, said sealant layer compostable under uncontrolled composting conditions, and
curing said laminated material for between approximately 48 to 72 hours at between approximately 70° F. and 80° F.,
wherein said laminated material is compostable under controlled or uncontrolled conditions.
